(19) United States
(12) Patent Application Publication
(10) Pub. No.: US 2021/0159614 A1
(43) Pub. Date: May 27, 2021

(54) ELECTRIC WIRE WITH TERMINAL AND TERMINAL BEFORE CRIMPING

(71) Applicant: Yazaki Corporation, Tokyo (JP)

(72) Inventors: Tomoya Sato, Shizuoka (JP); Hirotaka Takeda, Shizuoka (JP)

(21) Appl. No.: 17/102,465

(22) Filed: Nov. 24, 2020

(30) Foreign Application Priority Data
Nov. 27, 2019 (JP) 2019-213891

(51) Int. Cl. H01R 4/18

(52) U.S. Cl. CPC H01R 4/185

(57) ABSTRACT

In a terminal before crimping provided in an electric wire with a terminal, a conductor crimping portion crimped to a conductor portion of the electric wire includes a base and a pair of barrel pieces. The barrel piece has a notch formed at a corner close to a cover crimping portion of a distal end. The notch satisfies 10%≤(x1/a)×100≤75% and 12%≤(y/b)×100≤43% in a developed state before the conductor crimping portion is crimped to the conductor portion when the length of the barrel piece along an axial direction is a, the length of the notch along the axial direction is x1, the length along an orthogonal direction from a center position in the orthogonal direction to the distal end of the barrel piece is b, and the length of the notch along the orthogonal direction is y.

### CROSS-REFERENCE TO RELATED APPLICATION(S)

The present application claims priority to and incorporates by reference the entire contents of Japanese Patent Application No. 2019-213891 filed in Japan on Nov. 27, 2019.

### BACKGROUND OF THE INVENTION

### 1. Field of the Invention

The present invention relates to an electric wire with a terminal and a terminal before crimping.

### 2. Description of the Related Art

As a conventional electric wire with a terminal applied to a vehicle, for example, Japanese Patent Application Laid-open No. 2009-87848 discloses a crimp terminal for an aluminum electric wire including a connection portion between terminals and an electric wire connection portion having a barrel crimped to a conductor portion of the aluminum electric wire.

Meanwhile, the crimp terminal as described above has room for further improvement in terms of ensuring proper conduction performance, for example.

### SUMMARY OF THE INVENTION

The present invention has been made in view of the above circumstances, and an object thereof is to provide an electric wire with a terminal and a terminal before crimping which can ensure appropriate conduction performance.

In order to achieve the above mentioned object, an electric wire with a terminal according to one aspect of the present invention includes an electric wire whose conductive conductor portion is covered with an insulating cover portion having an insulating property; and a crimp terminal that includes a conductor crimping portion that is crimped to the conductor portion exposed from a terminal of the insulating cover portion, a cover crimping portion that is crimped to the insulating cover portion, and an intermediate portion that couples the conductor crimping portion and the cover crimping portion and exposes the conductor portion, wherein the conductor crimping portion includes a base extending along an axial direction along an axis of the conductor portion and a pair of barrel pieces respectively extending from the base on both sides of an intersection direction intersecting the axial direction, each of distal ends of the pair of barrel pieces being in contact with the conductor portion in a state where the conductor portion is wrapped and crimped by the base and the pair of barrel pieces, the barrel piece has a notch formed at a corner of the distal end close to the cover crimping portion and notched over the distal end and an end close to the cover crimping portion, and the notch satisfies 10%≤(x1/a)×100≤75% and 12%≤(y/b)×100≤43% in a developed state before the conductor crimping portion is crimped to the conductor portion when a length of the barrel piece along the axial direction is a, a length of the notch along the axial direction is x1, a length along an orthogonal direction from a center position of the base to the distal end of the barrel piece in the orthogonal direction orthogonal to the axial direction is b, and a length of the notch along the orthogonal direction is y.

According to another aspect of the present invention, in the electric wire with a terminal, it is possible to configure that the notch satisfies 18%≤(x1/a)×100≤46% and 19%≤(y/b)×100≤43% in the developed state before the conductor crimping portion is crimped to the conductor portion.

According to still another aspect of the present invention, in the electric wire with a terminal, it is possible to configure that the notch satisfies (y/b)×100=21% and 18%≤(x1/a)×100≤46%, or (x1/a)×100=21% and 19%≤(y/) b)×100≤43% in the developed state before the conductor crimping portion is crimped to the conductor portion.

In order to achieve the above mentioned object, an electric wire with a terminal according to still another aspect of the present invention includes an electric wire whose conductive conductor portion is covered with an insulating cover portion having an insulating property; and a crimp terminal that includes a conductor crimping portion that is crimped to the conductor portion exposed from a terminal of the insulating cover portion, a cover crimping portion that is crimped to the insulating cover portion, and an intermediate portion that couples the conductor crimping portion and the cover crimping portion and exposes the conductor portion, wherein the conductor crimping portion includes a base extending along an axial direction along an axis of the conductor portion and a pair of barrel pieces respectively extending from the base on both sides of an intersection direction intersecting the axial direction, each of distal ends of the pair of barrel pieces being in contact with the conductor portion in a state where the conductor portion is wrapped and crimped by the base and the pair of barrel pieces, the barrel piece has a notch formed at a corner of the distal end close to the cover crimping portion and notched over the distal end and an end close to the cover crimping portion, and the notch satisfies 43%≤(x2/(a+c))×100≤84% and 12%≤(y/b)×100≤43% in a developed state before the conductor crimping portion is crimped to the conductor portion when a length of the barrel piece along the axial direction is a, a length along the axial direction from an end of the cover crimping portion close to the conductor crimping portion to the end of the barrel piece close to the cover crimping portion is c, a length along the axial direction from the end of the cover crimping portion close to the conductor crimping portion to an end of the notch on a side opposite to the cover crimping portion is x2, a length along an orthogonal direction from a center position of the base to the distal end of the barrel piece in the orthogonal direction orthogonal to the axial direction is b, and a length of the notch along the orthogonal direction is y.

In order to achieve the above mentioned object, a terminal before crimping according to still another aspect of the present invention includes a crimp terminal that includes a conductor crimping portion that is crimped to a conductor portion exposed from a terminal of an insulating cover portion of an electric wire of which the conductor portion having conductivity is covered with the insulating cover portion having an insulating property, a cover crimping portion that is crimped to the insulating cover portion, and an intermediate portion that couples the conductor crimping portion and the cover crimping portion and exposes the conductor portion, wherein the conductor crimping portion includes a base extending along an axial direction along an axis of the conductor portion and a pair of barrel pieces respectively extending from the base on both sides of an intersection direction intersecting the axial direction, each of distal ends of the pair of barrel pieces being in contact with the conductor portion in a state where the conductor portion is wrapped and crimped by the base and the pair of barrel pieces, the barrel piece has a notch formed at a corner of the distal end close to the cover crimping portion and notched over the distal end and an end close to the cover crimping portion, and the notch satisfies 10%≤(x1/a)×100≤75% and 12%≤(y/b)×100≤43% in a developed state before the conductor crimping portion is crimped to the conductor portion when a length of the barrel piece along the axial direction is a, a length of the notch along the axial direction is x1, a length along an orthogonal direction from a center position of the base to the distal end of the barrel piece in the orthogonal direction orthogonal to the axial direction is b, and a length of the notch along the orthogonal direction is y.

In order to achieve the above mentioned object, a terminal before crimping according to still another aspect of the present invention includes a crimp terminal that includes a conductor crimping portion that is crimped to a conductor portion exposed from a terminal of an insulating cover portion of an electric wire of which the conductor portion having conductivity is covered with the insulating cover portion having an insulating property, a cover crimping portion that is crimped to the insulating cover portion, and an intermediate portion that couples the conductor crimping portion and the cover crimping portion and exposes the conductor portion, wherein the conductor crimping portion includes a base extending along an axial direction along an axis of the conductor portion and a pair of barrel pieces respectively extending from the base on both sides of an intersection direction intersecting the axial direction, each of distal ends of the pair of barrel pieces being in contact with the conductor portion in a state where the conductor portion is wrapped and crimped by the base and the pair of barrel pieces, the barrel piece has a notch formed at a corner of the distal end close to the cover crimping portion and notched over the distal end and an end close to the cover crimping portion, and the notch satisfies 43%≤(x2/(a+c))×100≤84% and 12%≤(y/b)×100≤43% in a developed state before the conductor crimping portion is crimped to the conductor portion when a length of the barrel piece along the axial direction is a, a length along the axial direction from an end of the cover crimping portion close to the conductor crimping portion to the end of the barrel piece close to the cover crimping portion is c, a length along the axial direction from the end of the cover crimping portion close to the conductor crimping portion to an end of the notch on a side opposite to the cover crimping portion is x2, a length along an orthogonal direction from a center position of the base to the distal end of the barrel piece in the orthogonal direction orthogonal to the axial direction is b, and a length of the notch along the orthogonal direction is y.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic cross-sectional view illustrating a schematic configuration of an electric wire with a terminal according to an embodiment;

FIG. 2 is a schematic perspective view including a swaging die for crimping a crimp terminal provided in the electric wire with a terminal according to the embodiment;

FIG. 3 is a schematic front view illustrating a schematic configuration of the crimp terminal provided in the electric wire with a terminal according to the embodiment;

FIG. 4 is a partial perspective view illustrating a schematic configuration of an electric wire crimping portion of the crimp terminal provided in the electric wire with a terminal according to the embodiment;

FIG. 5 is a schematic cross-sectional view of the electric wire with a terminal according to the embodiment;

FIG. 6 is a schematic cross-sectional view taken along line A-A illustrated in FIG. 5;

FIG. 7 is a schematic partial plan view of the crimp terminal provided in the electric wire with a terminal according to the embodiment in a developed state before crimping;

FIG. 8 is a table illustrating an evaluation result of the electric wire with a terminal according to the embodiment; and

FIG. 9 is a schematic partial cross-sectional view including a notch of a crimp terminal provided in an electric wire with a terminal according to a modification.

### DETAILED DESCRIPTION OF THE PREFERRED EMBODIMENTS

Hereinafter, an embodiment according to the present invention will be described in detail with reference to the drawings. Incidentally, the invention is not limited by the embodiment. In addition, constituent elements in the following embodiment include one that can be replaced easily by a person skilled in the art or substantially the same one.

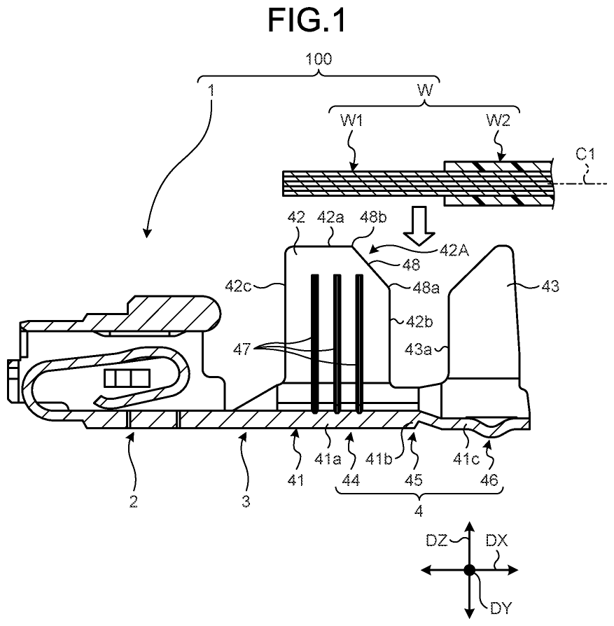

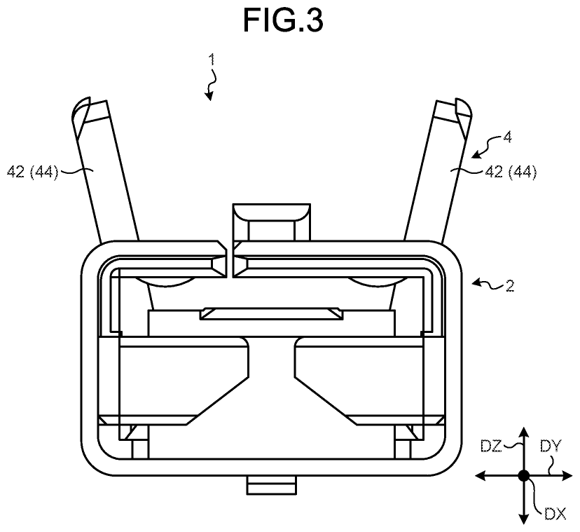

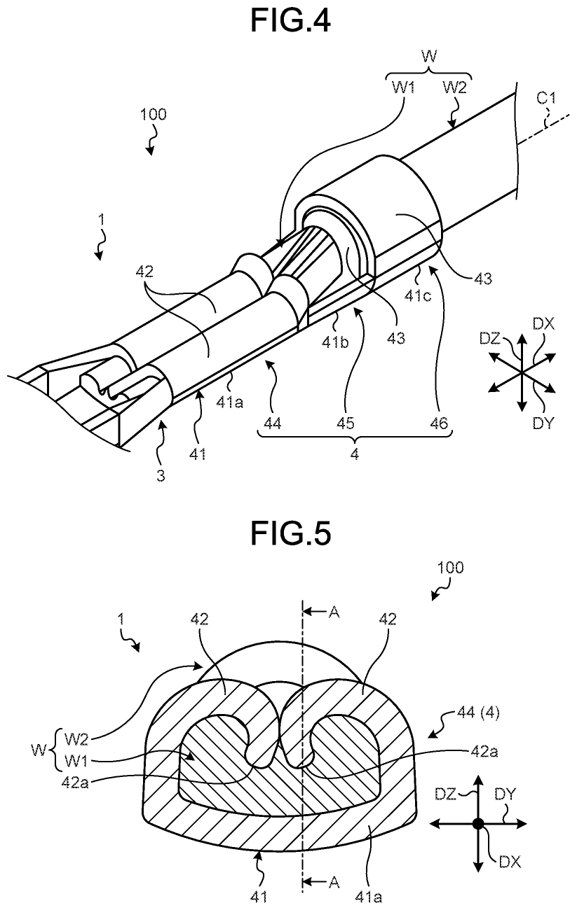

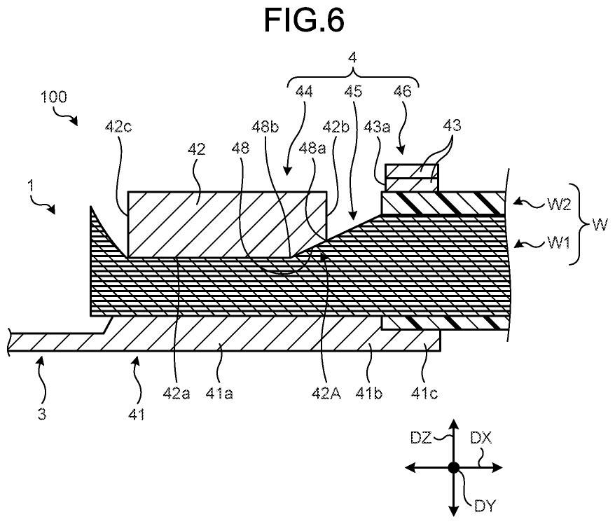

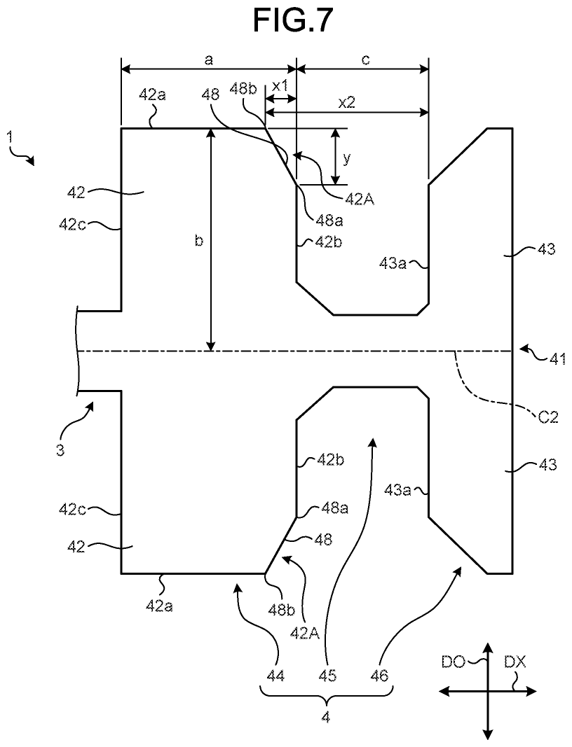

Incidentally, in the following description, among a first direction, a second direction, and a third direction which intersect each other in FIGS. 1 to 6, the first direction is referred to as an “axial direction DX”, the second direction is referred to as a “width direction DY”, and the third direction is referred to as a “height direction DZ”. Here, the axial direction DX, the width direction DY, and the height direction DZ are substantially orthogonal to each other. The axial direction DX typically corresponds to an axial direction along an axis C1 (see FIGS. 1 and 4) of an electric wire (a conductor portion or an insulating cover portion) provided with a crimp terminal, an extending direction in which the electric wire extends, an insertion/removal direction between the crimp terminal and a mating member, and the like. The width direction DY and the height direction DZ correspond to intersection directions intersecting the axial direction DX. In addition, FIGS. 1, 2, and 3 illustrate the crimp terminal before crimping (terminal before crimping), and FIGS. 4, 5, and 6 illustrate the crimp terminal after crimping (terminal after crimping). In addition, FIG. 7 illustrates a developed state before the crimp terminal is crimped to the electric wire, and illustrates a state where an electric wire crimping portion of the crimp terminal is developed in a flat plate shape. FIG. 7 is illustrated in a simplified manner as appropriate. In the following description, a direction orthogonal to the axial direction DX is referred to as an orthogonal direction DO in FIG. 7. In addition, each direction used in the following description indicates a direction in a state where the respective parts are assembled to each other unless otherwise specified.

### EMBODIMENT

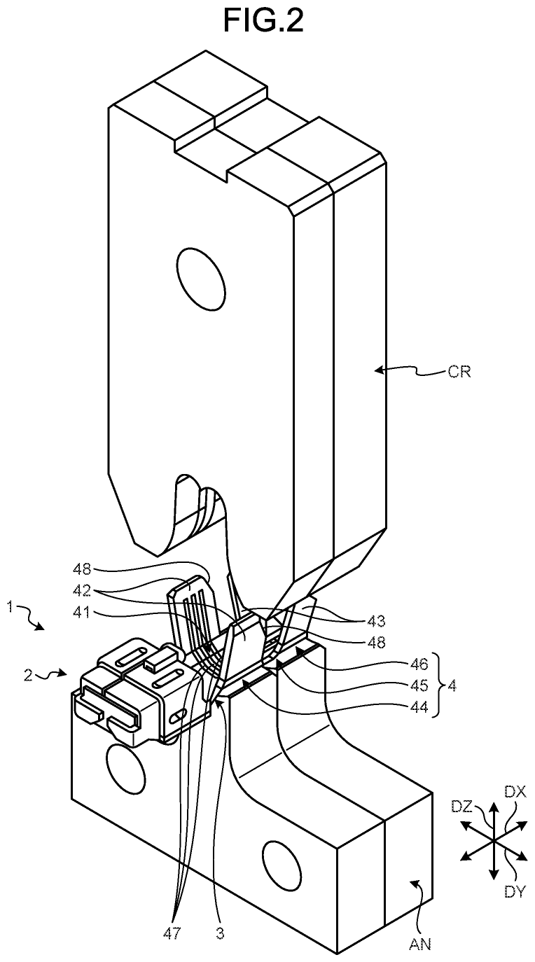

An electric wire with a terminal 100 of the present embodiment illustrated in FIG. 1 is applied to a wire harness or the like used in a vehicle. Here, the wire harness is obtained by, for example, bundling a plurality of electric wires W used for power supply and signal communication to form an aggregate for connection among devices mounted on the vehicle, and connecting the plurality of electric wires W to the respective devices by a connector or the like. The electric wire with a terminal 100 of the present embodiment includes the electric wire W and a crimp terminal 1 crimped to a terminal of the electric wire W. As illustrated in FIG. 2, the crimp terminal 1 of the present embodiment is a terminal that is crimped and electrically connected to the electric wire W by a crimper CR constituting a swaging die and an anvil AN. Further, the crimp terminal 1 of the present embodiment is formed by forming a notch 48 in a barrel piece 42 of a conductor crimping portion 44 to ensure both crimping strength and conduction performance and ensure proper conduction performance. Hereinafter, each configuration of the electric wire with a terminal 100 will be described in detail with reference to each drawing.

As illustrated in FIG. 1, the electric wire W includes a linear conductor portion W1 having conductivity and an insulating cover portion W2 that has an insulation property and covers the outside of the conductor portion W1. The electric wire W is an insulated wire in which the conductor portion W1 is covered with the insulating cover portion W2.

The conductor portion W1 is a core wire obtained by bundling a plurality of conductive metal strands. The conductor portion W1 may be a stranded core wire obtained by twisting the plurality of metal strands. The conductor portion W1 of the present embodiment is made of, for example, copper (Cu), a copper alloy, aluminum (Al), or an aluminum alloy. That is, the conductor portion W1 is the core wire obtained by bundling the plurality of metal strands made of copper, a copper alloy, aluminum, or an aluminum alloy.

The insulating cover portion W2 is an electric wire cover that covers the outer peripheral side of the conductor portion W1. The insulating cover portion W2 is formed, for example, by extrusion molding of an insulative resin material (such as PP, PVC, and cross-linked PE which is appropriately selected in consideration of wear resistance, chemical resistance, heat resistance, and the like).

The electric wire W extends linearly along the axis C1 and is formed so as to extend with substantially the same diameter in the extending direction (axial direction DX). The electric wire W has a substantially circular cross-sectional shape as a whole in which a cross-sectional shape of the conductor portion W1 (cross-sectional shape in a direction intersecting the axial direction DX) is substantially circular and a cross-sectional shape of the insulating cover portion W2 is a substantially annular shape. In the electric wire W, the insulating cover portion W2 is stripped off from at least one terminal of the conductor portion W1, the one terminal of the conductor portion W1 is exposed from the insulating cover portion W2, and the crimp terminal 1 is provided at the exposed terminal of the conductor portion W1.

As illustrated in FIGS. 1, 2, and 3, the crimp terminal 1 is a terminal fitting to which the electric wire W is electrically connected and a mating member having conductivity is connected. The crimp terminal 1 includes an electrical connection portion 2, a coupling portion 3, and an electric wire crimping portion 4. The electrical connection portion 2, the coupling portion 3, and the electric wire crimping portion 4 are integrally formed using a conductive metal member. The crimp terminal 1 is formed by molding a single sheet of metal by various types of processing, such as punching, pressing, and bending, according to a shape corresponding to each portion, such as the electrical connection portion 2, the coupling portion 3, and the electric wire crimping portion 4 such that the respective portions are three-dimensionally formed in an integrated manner. The crimp terminal 1 of the present embodiment is configured by, for example, plating a surface of a base material made of copper or a copper alloy with tin (Sn) or the like. In the crimp terminal 1, the electrical connection portion 2, the coupling portion 3, and the electric wire crimping portion 4 are arrayed in this order from one side to the other side along the axial direction DX and coupled to each other.

The electrical connection portion 2 is a portion that is electrically connected to the mating member. The mating member is, for example, a mating terminal. That is, here, the electrical connection portion 2 of the present embodiment is configured as a terminal connection portion that is electrically connected to the mating terminal as the mating member. The electrical connection portion 2 may have a male terminal shape or a female terminal shape. The electrical connection portion 2 of the present embodiment is illustrated as a female terminal shape, and is electrically connected to the mating member having a male terminal shape. Incidentally, the mating member does not have to be the mating terminal, and may be, for example, various conductive members such as a grounding member. In this case, the electrical connection portion 2 may have, for example, a so-called rounded terminal (LA terminal) shape that is fastened to a grounding member or the like as the mating member.

The coupling portion 3 is a portion that is interposed between the electrical connection portion 2 and the electric wire crimping portion 4 and couples the electrical connection portion 2 and the electric wire crimping portion 4. In the crimp terminal 1, the electrical connection portion 2 and the electric wire crimping portion 4 are electrically connected via the coupling portion 3, and the electrical connection portion 2 and the conductor portion W1 of the electric wire W are electrically connected and conducted through the electric wire crimping portion 4.

The electric wire crimping portion 4 is a portion to which the electric wire W is connected and electrically connects the terminal of the electric wire W and the crimp terminal 1. The electric wire crimping portion 4 is swaged and crimped to the terminal of the electric wire W. The electric wire crimping portion 4 includes a base 41 and two pairs of barrel pieces 42 and 43. The electric wire crimping portion 4 is swaged and crimped to the electric wire W through the base 41 and the two pairs of barrel pieces 42 and 43.

More specifically, the conductor crimping portion 44, an intermediate portion 45, and a cover crimping portion 46 are formed in the electric wire crimping portion 4 by the base 41 and the two pairs of barrel pieces 42 and 43. In other words, the electric wire crimping portion 4 includes the conductor crimping portion 44, the intermediate portion 45, and the cover crimping portion 46 made of the base 41 and the two pairs of barrel pieces 42 and 43.

The conductor crimping portion 44 is made of a part of the base 41 and a pair of barrel pieces 42. The intermediate portion 45 is made of a part of the base 41. The cover crimping portion 46 is made of a part of the base 41 and a pair of barrel pieces 43. In the electric wire crimping portion 4, the conductor crimping portion 44, the intermediate portion 45, and the cover crimping portion 46 are arrayed in this order from the electrical connection portion 2 side to the opposite side along the axial direction DX and coupled to each other. Further, the electric wire crimping portion 4 of the present embodiment forms a so-called separate barrel type crimping portion in which the pair of barrel pieces 42 and the pair of barrel pieces 43 are separated by the intermediate portion 45.

Specifically, the base 41 is a portion that extends along the axial direction DX and serves as a bottom wall of the electric wire crimping portion 4 formed in a substantially U shape in a state before crimping of the crimp terminal 1. The base 41 is formed in a plate shape in which a plate thickness direction extends along the height direction DZ. An end portion of the electric wire W is placed on the base 41 during crimping. The base 41 is coupled to the electrical connection portion 2 via the coupling portion 3 on one side of the axial direction DX. In each portion of the base 41, both ends in the width direction DY rise along the height direction DZ.

More specifically, the base 41 is continuous along the axial direction DX over the conductor crimping portion 44, the intermediate portion 45, and the cover crimping portion 46. That is, the base 41 is configured by arranging a first base 41a forming the conductor crimping portion 44, a second base 41b forming the intermediate portion 45, and a third base 41c forming the cover crimping portion 46 in a row along the axial direction DX (see FIG. 1). In the base 41, the electrical connection portion 2 is coupled to one end of the first base 41a in the axial direction DX. In addition, in the state before crimping, the base 41 has a carrier coupled to the other end of the third base 41c in the axial direction DX, and is cut from the carrier during the crimping, for example.

The pair of barrel pieces 42 are portions forming the conductor crimping portion 44 together with the first base 41a which is a part of the base 41. The conductor crimping portion 44 is a portion that is provided on one end side of the electric wire crimping portion 4 in the axial direction DX, here, on the electrical connection portion 2 side, and is swaged and crimped to the conductor portion W1 of the electric wire W. Furthermore, the conductor crimping portion 44 is a portion that is swaged and crimped to the conductor portion W1 to be electrically connected to the conductor portion W1.

The pair of barrel pieces 42 are portions that are formed in the conductor crimping portion 44 so as to extend in a strip shape on both sides in the width direction DY from the first base 41a and are swaged and crimped in the state of wrapping the conductor portion W1 of the electric wire W against the first base 41a. The pair of barrel pieces 42 are portions that serve as side walls of the electric wire crimping portion 4 formed in a U shape in the state before crimping. One barrel piece 42 extends from the first base 41a to one side in the width direction DY that intersects the axial direction DX. The other barrel piece 42 extends from the first base 41a to the other side in the width direction DY. The first base 41a is subjected to bending and the pair of barrel pieces 42 are formed into a substantially U shape together with the first base 41a in the state before being swaged and crimped to the conductor portion W1 of the electric wire W (see FIG. 2 and the like).

As illustrated in FIGS. 4 and 5, the pair of barrel pieces 42 of the present embodiment have lengths from the roots to distal ends 42a on the first base 41a side set not to be superimposed on (not to overlap) each other in the state of being wound, swaged, and crimped against the conductor portion W1. The conductor crimping portion 44 wraps the outside of the conductor portion W1 of the electric wire W arranged between the pair of barrel pieces 42 by the first base 41a and the pair of barrel pieces 42 and is swaged and crimped with respect to the conductor portion W1.

The pair of barrel pieces 42 of the present embodiment are subjected to swaging and crimping referred to as so-called B crimp. During the B crimp, each of the pair of barrel pieces 42 is in a state of being bent toward the first base 41a in the crimped state of the conductor crimping portion 44 wrapping the conductor portion W1 with the first base 41a and the pair of barrel pieces 42. Further, in this state, the conductor crimping portion 44 is swaged and crimped such that each of the distal ends 42a of the pair of barrel pieces 42 is in contact with and pressed against the conductor portion W1.

Incidentally, the conductor crimping portion 44 may have a plurality of serrations 47 or the like, configured to increase the contact area with the conductor portion W1 and to improve contact stability and adhesion strength, in the first base 41a and portions of the pair of barrel pieces 42 that come into contact with the conductor portion W1 as illustrated in FIGS. 1 and 2. The serration 47 is formed in a concave shape on the first base 41a and a surface of the barrel piece 42 close to the conductor portion W1 in the conductor crimping portion 44. In addition, the notch 48 is formed in each of the pair of barrel pieces 42 in the conductor crimping portion 44. The notch 48 will be described in detail later.

As illustrated in FIGS. 1 and 2, the pair of barrel pieces 43 are portions forming the cover crimping portion 46 together with the third base 41c which is a part of the base 41. The cover crimping portion 46 is a portion that is provided on the other end side of the electric wire crimping portion 4 in the axial direction DX, here, on the side opposite to the electrical connection portion 2 side, and is swaged and crimped to the insulating cover portion W2 of the electric wire W.

The pair of barrel pieces 43 are portions that are formed in the cover crimping portion 46 so as to extend in a strip shape on both sides in the width direction DY from the third base 41c and are swaged and crimped in the state of wrapping the insulating cover portion W2 of the electric wire W against the third base 41c. The pair of barrel pieces 43 are portions that serve as side walls of the electric wire crimping portion 4 formed in a U shape in the state before crimping. One barrel piece 43 extends from the third base 41c to one side in the width direction DY that intersects the axial direction DX. The other barrel piece 43 extends from the third base 41c to the other side in the width direction DY. The third base 41c is subjected to bending and the pair of barrel pieces 43 are formed into a substantially U shape together with the third base 41c in the state before being swaged and crimped to the insulating cover portion W2 of the electric wire W (see FIG. 2).

As illustrated in FIG. 4, the pair of barrel pieces 43 of the present embodiment have lengths from the roots to distal ends on the third base 41c side set so as to be superimposed on (to overlap) each other in the state of being wound, swaged, and crimped against the insulating cover portion W2. The cover crimping portion 46 wraps the outside of the insulating cover portion W2 of the electric wire W arranged between the pair of barrel pieces 43 by the third base 41c and the pair of barrel pieces 43 and is swaged and crimped with respect to the insulating cover portion W2.

Note that each of the pair of barrel pieces 43 is formed such that the distal end portion is tapered toward the distal end side here, but the present invention is not limited thereto.

Here, the intermediate portion 45 in the electric wire crimping portion 4 is interposed between the cover crimping portion 46 and the conductor crimping portion 44 with respect to the axial direction DX. The intermediate portion 45 is a portion that is interposed between the conductor crimping portion 44 and the cover crimping portion 46 and couples the conductor crimping portion 44 and the cover crimping portion 46. The intermediate portion 45 is configured using the second base 41b, the first base 41a of the conductor crimping portion 44 is coupled to an end of the second base 41b on one side in the axial direction DX, and the third base 41c of the cover crimping portion 46 is coupled to an end on the other side. Further, the intermediate portion 45 forms a portion where an intermediate exposed portion of the conductor portion W1 is exposed. As described above, the pair of barrel pieces 42 and the pair of barrel pieces 43 are formed so as to be separated from each other by interposing the intermediate portion 45 therebetween.

In the electric wire with a terminal 100 configured as described above, the conductor crimping portion 44 is crimped to the conductor portion W1 and the cover crimping portion 46 is crimped to the insulating cover portion W2 by the crimper CR and the anvil AN so that the crimp terminal 1 is crimped to the terminal of the electric wire W. Further, in the electric wire with a terminal 100, the mating member is electrically connected to the electrical connection portion 2 of the crimp terminal 1.

Further, the crimp terminal 1 provided in the electric wire with a terminal 100 of the present embodiment has the notch 48 provided at a predetermined ratio with respect to the barrel piece 42 of the conductor crimping portion 44 in the above configuration as illustrated in FIGS. 1, 6 and 7. With this configuration, the crimp terminal 1 ensures both the crimping strength and conduction performance as described above.

Specifically, each of the barrel pieces 42 is formed in a substantially rectangular plate shape along the direction orthogonal to the axial direction DX (orthogonal direction DO in FIG. 7 in the developed state), and the notch 48 is formed at a corner 42A of the distal end 42a close to the cover crimping portion 46. The notch 48 is a portion of the corner 42A of the barrel piece 42 that is cut out in a substantially triangular shape over the distal end 42a and an end 42b close to the cover crimping portion 46. In other words, the corner 42A of the barrel piece 42 has a shape cut out in a substantially triangular shape over the distal end 42a and the end 42b by the notch 48.

Further, as illustrated in FIG. 7, the notch 48 of the present embodiment is formed to satisfy 10%≤(x1/a)×100≤75% and 12%≤(y/b)×100≤43% in the developed state before the conductor crimping portion 44 is crimped to the conductor portion W1 when the length of the barrel piece 42 along the axial direction DX is “a”, and the length of the notch 48 along the axial direction DX is “x1”, the length along the orthogonal direction DO from a center position C2 of the base 41 in the orthogonal direction DO to the distal end 42a of the barrel piece 42 is “b”, and the length of the notch 48 along the orthogonal direction DO is “y”.

That is, when a first axial direction ratio index representing a ratio of the length “x1” of the notch 48 relative to the length “a” of the barrel piece 42 is “X1=(x1/a)×100” and an orthogonal direction ratio index representing a ratio of the length “y” of the notch 48 relative to the length “b” from the center position C2 of the base 41 to the distal end 42a of the barrel piece 42 is “Y=(y/b)×100”, the notch 48 of the present embodiment satisfies the following Formula (1-1).

10%≤X1≤75% and 12%≤Y≤43% (1-1)

Here, the length “a” of the barrel piece 42 along the axial direction DX corresponds, more specifically, to the length along the axial direction DX from the end 42b of the barrel piece 42 on the cover crimping portion 46 side to an end 42c on the side opposite to the cover crimping portion 46 side. In addition, the length “x1” of the notch 48 along the axial direction DX corresponds to the length along the axial direction DX from an end 48a of the notch 48 on the cover crimping portion 46 side to an end 48b on the side opposite to the cover crimping portion 46 side. In addition, the length “y” of the notch 48 along the orthogonal direction DO corresponds to the length along the orthogonal direction DO from the end 48b of the notch 48 on the distal end 42a side to the end 48a on the side opposite to the distal end 42a side. Incidentally, the barrel piece 42 has the distal end 42a along the axial direction DX and the ends 42b and 42c along the orthogonal direction DO in the developed state illustrated in FIG. 7.

Incidentally, the notch 48 of the present embodiment is preferably formed so as to satisfy 18%≤(x1/a)×100≤46% and 19%≤(y/b)×100≤43% in the developed state before the conductor crimping portion 44 is crimped to the conductor portion W1. When expressing this using the first axial direction ratio index “X1” and the orthogonal direction ratio index “Y”, the notch 48 preferably satisfies the following Formula (1-2).

18%≤X1≤46% and 19%≤Y≤43% (1-2)

Furthermore, the notch 48 of the present embodiment is more preferably formed so as to satisfy (y/b)×100=21% and 18%≤(x1/a)×100≤46% or (x1/a)×100=21% and 19%≤(y/b)×100≤43% in the developed state before the conductor crimping portion 44 is crimped to the conductor portion W1. When expressing this using the first axial direction ratio index “X1” and the orthogonal direction ratio index “Y”, the notch 48 preferably satisfies the following Formula (1-3) or Formula (1-4).

Y=21% and 18%≤X1≤46% (1-3)

X1=21% and 19%≤Y≤43% (1-4)

Further, the notch 48 of the present embodiment is most preferably formed so as to satisfy (x1/a)×100=21% and (y/b)×100=21% in the developed state before the conductor crimping portion 44 is crimped to the conductor portion W1. When expressing this using the first axial direction ratio index “X1” and the orthogonal direction ratio index “Y”, the notch 48 most preferably satisfies the following Formula (1-5).

X1=21% and Y=21% (1-5)

In addition, it can be also said that the notch 48 of the present embodiment is formed so as to satisfy 43%≤(x2/(a+c))×100≤84% and 12%≤(y/b)×100≤43% in the developed state before the conductor crimping portion 44 is crimped to the conductor portion W1 as illustrated in FIG. 7 when the length of the barrel piece 42 along the axial direction DX is defined as “a”, the length along the axial direction DX from an end 43a of the barrel piece 43 of the cover crimping portion 46 on the conductor crimping portion 44 side to the end 42b of the barrel piece 42 on the cover crimping portion 46 side is “c”, the length along the axial direction DX from the end 43a of the barrel piece 43 of the cover crimping portion 46 on the conductor crimping portion 44 side to the end 48b of the notch 48 on the side opposite to the cover crimping portion 46 side is “x2”, the length along the orthogonal direction DO from the center position C2 of the base 41 in the orthogonal direction DO to the distal end 42a of the barrel piece 42 is “b”, and the length of the notch 48 along the orthogonal direction DO is “y”.

That is, it can be also said that the notch 48 of the present embodiment satisfies the following Formula (2-1) when a second axial direction ratio index, which represents a ratio of the length “x2” from the end 43a of the barrel piece 43 of the cover crimping portion 46 on the conductor crimping portion 44 side to the end 48b of the notch 48 on the side opposite to the cover crimping portion 46 side relative to the length “a+c” from the end 43a of the barrel piece 43 of the cover crimping portion 46 on the conductor crimping portion 44 side to the end 42c of the barrel piece 42 on the side opposite to the cover crimping portion 46 side, is “X2=(x2/(a+c))×100” and an orthogonal direction ratio index, which represents a ratio of the length “y” of the notch 48 relative to the length “b” from the center position C2 of the base 41 to the distal end 42a of the barrel piece 42, is “Y=(y/b)×100”. Incidentally, the end 43a of the barrel piece 43 extends along the orthogonal direction DO in the developed state illustrated in FIG. 7.

43%≤X1≤84% and 12%≤Y≤43% (2-1)

In this case, the notch 48 of the present embodiment is preferably formed so as to satisfy 48%≤(x2/(a+c))×100≤66% and 19%≤(y/b)×100≤43% in the developed state before the conductor crimping portion 44 is crimped to the conductor portion W1. When expressing this using the second axial direction ratio index “X2” and the orthogonal direction ratio index “Y”, the notch 48 preferably satisfies the following Formula (2-2).

48%≤X2≤66 and 19%≤Y≤43% (2-2)

Furthermore, the notch 48 of the present embodiment is more preferably formed so as to satisfy (y/b)×100=21% and 48%≤(x2/(a+c))×100≤66% or (x2/(a+c))×100=50% and 19%≤(y/b)×100≤43% in the developed state before the conductor crimping portion 44 is crimped to the conductor portion W1. When expressing this using the second axial direction ratio index “X2” and the orthogonal direction ratio index “Y”, the notch 48 preferably satisfies the following Formula (2-3) or Formula (2-4).

Y=21% and 48%≤X2≤66% (2-3)

X2=50% and 19%≤Y≤43% (2-4)

Further, in this case, the notch 48 of the present embodiment is most preferably formed so as to satisfy (x2/(a+c))×100=50% and (y/b)×100=21% in the developed state before the conductor crimping portion 44 is crimped to the conductor portion W1. When expressing this using the second axial direction ratio index “X2” and the orthogonal direction ratio index “Y”, the notch 48 most preferably satisfies the following Formula (2-5).

X2=50% and Y=21% (2-5)

The crimp terminal 1 configured as described above has the notch 48 formed at the corner 42A of the distal end 42a of the barrel piece 42 of the conductor crimping portion 44, and thus, can suppress occurrence of strand breakage of the conductor portion W1, that is, so-called core wire breakage in the conductor crimping portion 44. That is, the crimp terminal 1 has the notch 48 formed at the corner 42A of the distal end 42a of the barrel piece 42, and thus, can mitigate stress concentration applied to the strand of the conductor portion W1 by an edge portion of the distal end 42a and suppress the damage of the strand when crimping the barrel piece 42 to the conductor portion W1. As a result, the crimp terminal 1 can suppress the occurrence of the core wire breakage as described above. In the crimp terminal 1, the effect of suppressing the core wire breakage tends to be relatively large as the area of the notch 48 becomes relatively large.

Meanwhile, in the crimp terminal 1, there is a trade-off in which the crimping strength (in other words, a fixing force) between the conductor crimping portion 44 and the conductor portion W1 is relatively reduced as the notch 48 is formed in the barrel piece 42 of the conductor crimping portion 44 and the area of the barrel piece 42 itself is reduced. In the crimp terminal 1, the degree of reduction in the crimping strength tends to increase as the area of the notch 48 becomes relatively large.

On the other hand, the crimp terminal 1 of the present embodiment can eliminate the trade-off in which the crimping strength between the conductor crimping portion 44 and the conductor portion W1 is reduced due to the notch 48 formed in the barrel piece 42 in a well-balanced manner by forming the notch 48 so as to satisfy the above dimensional conditions. That is, the crimp terminal 1 can sufficiently ensure the crimping strength between the conductor crimping portion 44 and the conductor portion W1 by forming the notch 48 to satisfy the above dimensional conditions and suppressing the occurrence of the core wire breakage due to the notch 48.

As a result, the crimp terminal 1 of the present embodiment can suppress the core wire breakage while ensuring the appropriate crimping strength, and thus, can suppress an increase in resistance of a conducting portion between the conductor crimping portion 44 and the conductor portion W1 and ensure appropriate conduction performance. Therefore, the crimp terminal 1 can achieve both ensuring the crimping strength and ensuring the conduction performance obtained by suppressing the core wire breakage in a well-balanced manner.

Incidentally, regarding the degree of reduction in the crimping strength due to the notch 48 in the crimp terminal 1, the effect of the length “x1” of the notch 48 tends to be relatively larger than the effect of the length “y” of the notch 48. That is, the degree of reduction in the crimping strength in the crimp terminal 1 tends to be relatively larger in the case where the length “x1” of the notch 48 is made relatively longer than in the case where the length “y” of the notch 48 is relatively longer. A reason thereof is presumed that the amount the distal end 42a bitten between strands of the conductor portion W1 tends to be relatively smaller at the distal end 42a of the barrel piece 42 as the length “x1” of the notch 48 is relatively longer in the crimp terminal 1.

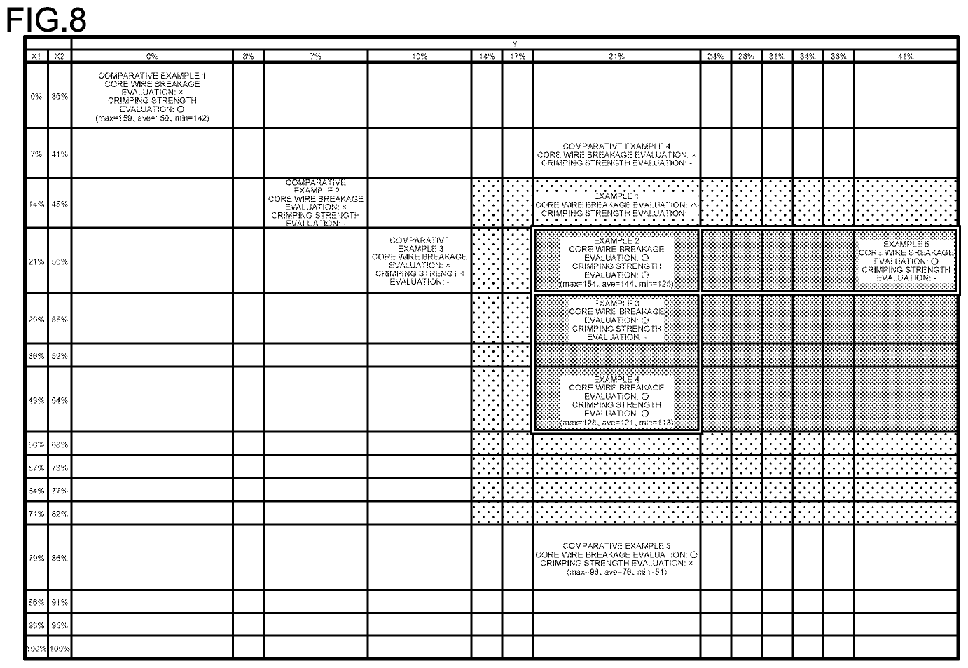

Next, a description will be given regarding an evaluation test on the core wire breakage and the crimping strength of the electric wire with a terminal 100 with reference to FIG. 8. FIG. 8 is a table illustrating evaluation results of the core wire breakage and the crimping strength of the electric wire with a terminal 100 according to the embodiment.

In this evaluation test, the core wire breakage and the crimping strength were evaluated by actually producing examples in which the notch 48 satisfying any of the conditional expressions expressed in the above Formulas (1-1) to (2-5) was formed in the barrel piece 42 in the electric wire with a terminal 100 according to the embodiment described above.

In “Example 1”, the barrel piece 42 and the notch 48 were formed such that the length “a”=7.0 mm, the length “b”=14.5 mm, the length “c”=4.0 mm, the length “x1”=1.0 mm, the length “x2”=5.0 mm, and the length “y”=3.0 mm. That is, “Example 1” is obtained by forming the notch 48, which has the first axial direction ratio index X1=14% and the second axial direction ratio index X2=45%, and the orthogonal direction ratio index Y=21%, in the barrel piece 42, and satisfies Formulas (1-1) and (2-1).

In “Example 2”, the barrel piece 42 and the notch 48 were formed such that the length “a”=7.0 mm, the length “b”=14.5 mm, the length “c”=4.0 mm, the length “x1”=1.5 mm, the length “x2”=5.5 mm, and the length “y”=3.0 mm. That is, “Example 2” is obtained by forming the notch 48, which has the first axial direction ratio index X1=21% and the second axial direction ratio index X2=50%, and the orthogonal direction ratio index Y=21%, in the barrel piece 42, and satisfies all of Formulas (1-1) to (2-5).

In “Example 3”, the barrel piece 42 and the notch 48 were formed such that the length “a”=7.0 mm, the length “b”=14.5 mm, the length “c”=4.0 mm, the length “x1”=2.0 mm, the length “x2”=6.0 mm, and the length “y”=3.0 mm. That is, “Example 3” is obtained by forming the notch 48, which has the first axial direction ratio index X1=29% and the second axial direction ratio index X2=55%, and the orthogonal direction ratio index Y=21%, in the barrel piece 42, and satisfies Formulas (1-1), (1-2), (1-3), (2-1), (2-2), and (2-3).

In “Example 4”, the barrel piece 42 and the notch 48 were formed such that the length “a”=7.0 mm, the length “b”=14.5 mm, the length “c”=4.0 mm, the length “x1”=3.0 mm, the length “x2”=7.0 mm, and the length “y”=3.0 mm. That is, “Example 4” is obtained by forming the notch 48, which has the first axial direction ratio index X1=43% and the second axial direction ratio index X2=64%, and the orthogonal direction ratio index Y=21%, in the barrel piece 42, and satisfies Formulas (1-1), (1-2), (1-3), (2-1), (2-2), and (2-3).

In “Example 5”, the barrel piece 42 and the notch 48 were formed such that the length “a”=7.0 mm, the length “b”=14.5 mm, the length “c”=4.0 mm, the length “x1”=1.5 mm, the length “x2”=5.5 mm, and the length “y”=6.0 mm. That is, “Example 5” is obtained by forming the notch 48, which has the first axial direction ratio index X1=21% and the second axial direction ratio index X2=50%, and the orthogonal direction ratio index Y=41%, in the barrel piece 42, and satisfies Formulas (1-1), (1-2), (1-4), (2-1), (2-2), and (2-4).

Meanwhile, in this evaluation test, the core wire breakage and the crimping strength were also evaluated by actually producing comparative examples that do not satisfy any of the conditional expressions illustrated in the above Formulas (1-1) to (2-5) for comparison with the examples.

“Comparative Example 1” is obtained by forming the barrel piece 42 and not forming the notch 48 such that the length “a”=7.0 mm, the length “b”=14.5 mm, the length “c”=4.0 mm, the length “x1”=0 mm, the length “x2”=4.0 mm, and the length “y”=0 mm. That is, “Comparative Example 1” has the first axial direction ratio index X1=0%, the second axial direction ratio index X2=36%, and the orthogonal direction ratio index Y=0%.

In “Comparative Example 2”, the barrel piece 42 and the notch 48 were formed such that the length “a”=7.0 mm, the length “b”=14.5 mm, the length “c”=4.0 mm, the length “x1”=1.0 mm, the length “x2”=5.0 mm, and the length “y”=1.0 mm. That is, “Comparative Example 2” is obtained by forming the notch 48 in the barrel piece 42 such that the first axial direction ratio index X1=14%, the second axial direction ratio index X2=45%, and the orthogonal direction ratio index Y=7%.

In “Comparative Example 3”, the barrel piece 42 and the notch 48 were formed such that the length “a”=7.0 mm, the length “b”=14.5 mm, the length “c”=4.0 mm, the length “x1”=1.5 mm, the length “x2”=5.5 mm, and the length “y”=1.5 mm. That is, “Comparative Example 3” is obtained by forming the notch 48 in the barrel piece 42 such that the first axial direction ratio index X1=21%, the second axial direction ratio index X2=50%, and the orthogonal direction ratio index Y=10%.

In “Comparative Example 4”, the barrel piece 42 and the notch 48 were formed such that the length “a”=7.0 mm, the length “b”=14.5 mm, the length “c”=4.0 mm, the length “x1”=0.5 mm, the length “x2”=4.5 mm, and the length “y”=3.0 mm. That is, “Comparative Example 4” is obtained by forming the notch 48 in the barrel piece 42 such that the first axial direction ratio index X1=7%, the second axial direction ratio index X2=41%, and the orthogonal direction ratio index Y=21%.

In “Comparative Example 5”, the barrel piece 42 and the notch 48 were formed such that the length “a”=7.0 mm, the length “b”=14.5 mm, the length “c”=4.0 mm, the length “x1”=5.5 mm, the length “x2”=9.5 mm, and the length “y”=3.0 mm. That is, “Comparative Example 5” is obtained by forming the notch 48 in the barrel piece 42 such that the first axial direction ratio index X1=79%, the second axial direction ratio index X2=86%, and the orthogonal direction ratio index Y=21%.

Further, in this evaluation test, for the electric wires with terminals of “Example 1” to “Example 5” and “Comparative Example 1” to “Comparative Example 5”, the core wire breakage was evaluated as follows. That is, ten electric wires with terminals according to each of “Example 1” to “Example 5” and “Comparative Example 1” to “Comparative Example 5” were produced, and the number of broken wires of the conductor portion W1 in the conductor crimping portion 44 during crimping of the crimp terminal was counted. Note that, here, variations within a range of ±2% were allowed as a range with approximately the same performance for each of the first axial direction ratio index “X1”, the second axial direction ratio index “X2”, and the orthogonal direction ratio index “Y” in each of “Example 1” to “Example 5” and “Comparative Example 1” to “Comparative Example 5”. In this core wire breakage evaluation, each of “Example 1” to “Example 5” and “Comparative Example 1” to “Comparative Example 5” was evaluated as “appropriate (OK)” if the number of broken wires in the conductor portion W1 is equal to or less than a predetermined ratio (10% in this case) and evaluated as “inappropriate (NG)” if the number of broken wires in the conductor portion W1 exceeds the predetermined ratio (10% in this case). In FIG. 8, among those evaluated as “appropriate (OK)”, one without core wire breakage is displayed as “core wire breakage evaluation: circle”, and one for which the core wire breakage occurred but the number was equal to or less than the predetermined ratio is displayed as “core wire breakage evaluation: triangle”, and those evaluated as “inappropriate (NG)” are displayed as “core wire breakage evaluation: X”.

Further, in this evaluation test, for the electric wires with terminals of “Example 2”, “Example 4”, “Comparative Example 1”, and “Comparative Example 5”, the crimping strength was also evaluated as follows. That is, ten electric wires with terminals of each of “Example 2”, “Example 4”, “Comparative Example 1”, and “Comparative Example 5” were produced, and tensile strength at the time of pulling the electric wire W to break the conductor crimping portion 44 and the conductor portion W1 was measured and used as the crimping strength. Note that, here, variations within a range of ±2% were also allowed as a range with approximately the same performance for each of the first axial direction ratio index “X1”, the second axial direction ratio index “X2”, and the orthogonal direction ratio index “Y” in each of “Example 2”, “Example 4”, “Comparative Example 1”, and “Comparative Example 5”. Further, in each of “Example 2”, “Example 4”, “Comparative Example 1”, and “Comparative Example 5”, the evaluation was performed by assuming a design-required crimping strength required in advance for design as reference strength “100” and the crimping strength measured as described above as a relative evaluation value with respect to the reference strength “100”. The relative evaluation value of “100” or more indicates that the crimping strength is equal to or larger than the design-required crimping strength, and the relative evaluation value less than “100” indicates that the crimping strength is smaller than the design-required crimping strength. In this crimping strength evaluation, each of “Example 2”, “Example 4”, “Comparative Example 1”, and “Comparative Example 5” was evaluated as “appropriate (OK)” if a maximum value (max), an average value (ave), and a minimum value (min) of the relative evaluation value were “100” or more and evaluated as “inappropriate (NG)” if the maximum value (max), the average value (ave), and the minimum value (min) of the relative evaluation value were less than “100”. In FIG. 8, one evaluated as “appropriate (OK)” is displayed as “crimping strength evaluation: circle”, and one evaluated as “inappropriate (NG)” is displayed as “crimping strength evaluation: X”.

As a result of the above core wire breakage evaluation, the core wire breakage occurred at 50% in “Comparative Example 1”, and the core wire breakage occurred at 20% in “Comparative Example 2”, “Comparative Example 3”, and “Comparative Example 4”. On the other hand, the core wire breakage occurred at 10% but fell within the predetermined ratio in “Example 1”, and no core wire breakage occurred in “Comparative Example 5”, “Example 2”, “Example 3”, and “Example 4”. Accordingly, it is clear that the effect of suppressing the core wire breakage is not sufficiently obtained in “Comparative Example 1”, “Comparative Example 2”, “Comparative Example 3”, and “Comparative Example 4” because the notch 48 is not formed or the area of the notch 48 is too small. On the other hand, it is clear that the core wire breakage can be significantly suppressed and the effect of suppressing the core wire breakage can be sufficiently obtained in “Comparative Example 5”, “Example 2”, “Example 3”, and “Example 4” since the area of the notch 48 is sufficiently ensured.

In addition, as a result of the above crimping strength evaluation, “Comparative Example 5” had the maximum value (max)=96, the average value (ave)=76, and the minimum value (min)=51 of the relative evaluation values, and crimping strength sufficient for the design-required crimping strength was not obtained. On the other hand, “Comparative Example 1” had the maximum value (max)=159, the average value (ave)=150, and the minimum value (min)=142 of the relative evaluation values, “Example 2” had the maximum value (max)=154, the average value (ave)=144, and the minimum value (min)=125 of the relative evaluation values, and “Example 4” had the maximum value (max)=128, the average value (ave)=121, and the minimum value (min)=113 of the relative evaluation value, and crimping strength sufficient for the design-required crimping strength was obtained in these examples.

Accordingly, it is clear that the sufficient crimping strength was not obtained because the area of the notch 48 was too large in “Comparative Example 5”. On the other hand, it is clear that the sufficient crimping strength has been obtained since the area of the notch 48 is not too large in “Comparative Example 1”, “Example 2”, and “Example 4”. In addition, from the tendency of magnitude of the relative evaluation values of “Example 2”, “Example 4”, “Comparative Example 1”, and “Comparative Example 5”, it is also clear that the degree of reduction in the crimping strength tends to increase as the area of the notch 48 is relatively larger.

As described above, the effect of suppressing the core wire breakage has not been sufficiently obtained in “Comparative Example 1”, “Comparative Example 2”, “Comparative Example 3”, and “Comparative Example 4” because the notch 48 is not formed or the area of the notch 48 is too small. On the contrary, the sufficient crimping strength has not been obtained in “Comparative Example 5” because the area of the notch 48 is too large although the effect of suppressing the core wire breakage has been sufficiently obtained.

On the other hand, it is clear that “Example 1” to “Example 5” in which the notch 48 satisfying any of the conditional expressions illustrated in the above Formulas (1-1) to (2-5) is formed in the barrel piece 42 has sufficiently ensured the crimping strength while sufficiently obtaining the effect of suppressing the core wire breakage. That is, it is clear that “Example 1” to “Example 5” can eliminate the trade-off in which the crimping strength between the conductor crimping portion 44 and the conductor portion W1 is reduced due to the notch 48 formed in the barrel piece 42 in a well-balanced manner by forming the notch 48 so as to satisfy the above dimensional conditions.

The electric wire with a terminal 100 and the terminal before crimping 1 described above have the notch 48 formed at the corner 42A of the barrel piece 42 of the conductor crimping portion 44 so as to satisfy at least Formulas (1-1) and (2-1). With this configuration, the electric wire with a terminal 100 and the terminal before crimping 1 can suppress the core wire breakage while ensuring the appropriate crimping strength, and thus, can suppress the increase in resistance of the conducting portion between the conductor crimping portion 44 and the conductor portion W1 and ensure the appropriate conduction performance. As a result, the electric wire with a terminal 100 and the terminal before crimping 1 can achieve both ensuring the crimping strength and ensuring the conduction performance obtained by suppressing the core wire breakage in a well-balanced manner, and ensure the appropriate conduction performance.

Further, the electric wire with a terminal 100 and the terminal before crimping 1 described above can achieve both ensuring the crimping strength and ensuring the conduction performance obtained by suppressing the core wire breakage in a more balanced manner and ensure the conduction performance more appropriately as the notch 48 is formed to satisfy Formulas (1-2) and (2-2).

Furthermore, the electric wire with a terminal 100 and the terminal before crimping 1 described above can achieve both ensuring the crimping strength and ensuring the conduction performance obtained by suppressing the core wire breakage in a still more balanced manner and ensure the conduction performance still more appropriately as the notch 48 is formed to satisfy any of Formulas (1-3), (1-4), (2-3), and (2-4).

Incidentally, the electric wire with a terminal and the terminal before crimping according to the embodiment of the present invention described above are not limited to the above-described embodiment, and various modifications can be made within the scope described in the claims.

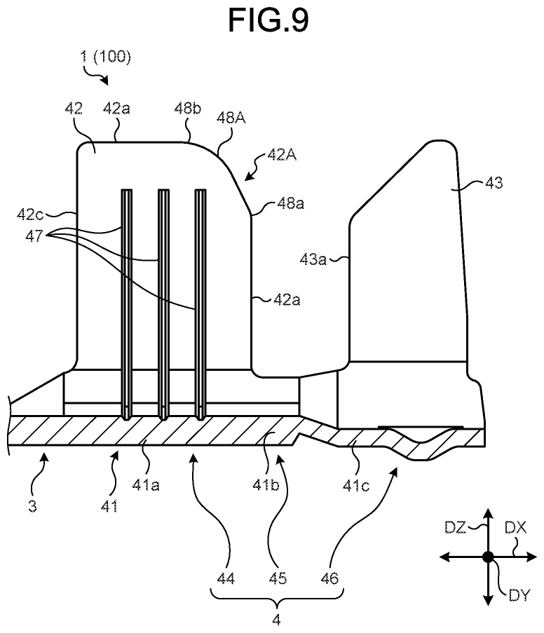

For example, a notch 48A is formed in the barrel piece 42 instead of the notch 48 in the crimp terminal 1 according to a modification illustrated in FIG. 9. The notch 48A is different from the notch 48 in terms that portions of the distal end 42a and the end 42b connected to straight portions, in other words, the ends 48a and 48b are subjected to rounding processing (curved surface processing). Other configurations of the notch 48A are substantially the same as those of the notch 48 described above. The crimp terminal 1 according to the modification can further mitigate the stress concentration applied to the strand of the conductor portion W1 by the edge portion such as the distal end 42a at the time of crimping the barrel piece 42 to the conductor portion W1 since the rounding processing are applied to the ends 48a and 48b of the notch 48A. As a result, the crimp terminal 1 according to the modification can more reliably suppress the core wire breakage, and can more appropriately ensure the conduction performance.

The electric wire with a terminal and the terminal before crimping according to the present embodiment may be configured by appropriately combining the components of the embodiment and the modification described above.

The electric wire with a terminal and the terminal before crimping according to the present embodiment have an effect that appropriate conduction performance can be ensured with the above configuration.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electric wire with a terminal comprising:
an electric wire whose conductive conductor portion is covered with an insulating cover portion having an insulating property; and
a crimp terminal that includes
a conductor crimping portion that is crimped to the conductor portion exposed from a terminal of the insulating cover portion,
a cover crimping portion that is crimped to the insulating cover portion, and
an intermediate portion that couples the conductor crimping portion and the cover crimping portion and exposes the conductor portion, wherein
the conductor crimping portion includes a base extending along an axial direction along an axis of the conductor portion and a pair of barrel pieces respectively extending from the base on both sides of an intersection direction intersecting the axial direction, each of distal ends of the pair of barrel pieces being in contact with the conductor portion in a state where the conductor portion is wrapped and crimped by the base and the pair of barrel pieces,
the barrel piece has a notch formed at a corner of the distal end close to the cover crimping portion and notched over the distal end and an end close to the cover crimping portion, and
the notch satisfies 10%≤(x1/a)×100≤75% and 12%≤(y/b)×100≤43% in a developed state before the conductor crimping portion is crimped to the conductor portion when a length of the barrel piece along the axial direction is a, a length of the notch along the axial direction is x1, a length along an orthogonal direction from a center position of the base to the distal end of the barrel piece in the orthogonal direction orthogonal to the axial direction is b, and a length of the notch along the orthogonal direction is y.

2. The electric wire with a terminal according to claim 1, wherein
the notch satisfies 18%≤(x1/a)×100≤46% and 19%≤(y/b)×100≤43% in the developed state before the conductor crimping portion is crimped to the conductor portion.

3. The electric wire with a terminal according to claim 1, wherein
the notch satisfies (y/b)×100=21% and 18%≤(x1/a)×100≤46%, or (x1/a)×100=21% and 19%≤(y/) b)×100≤43% in the developed state before the conductor crimping portion is crimped to the conductor portion.

4. The electric wire with a terminal according to claim 2, wherein
the notch satisfies (y/b)×100=21% and 18%≤(x1/a)×100≤46%, or (x1/a)×100=21% and 19%≤(y/) b)×100≤43% in the developed state before the conductor crimping portion is crimped to the conductor portion.

5. An electric wire with a terminal comprising:
an electric wire whose conductive conductor portion is covered with an insulating cover portion having an insulating property; and
a crimp terminal that includes
a conductor crimping portion that is crimped to the conductor portion exposed from a terminal of the insulating cover portion,
a cover crimping portion that is crimped to the insulating cover portion, and
an intermediate portion that couples the conductor crimping portion and the cover crimping portion and exposes the conductor portion, wherein
the conductor crimping portion includes a base extending along an axial direction along an axis of the conductor portion and a pair of barrel pieces respectively extending from the base on both sides of an intersection direction intersecting the axial direction, each of distal ends of the pair of barrel pieces being in contact with the conductor portion in a state where the conductor portion is wrapped and crimped by the base and the pair of barrel pieces,
the barrel piece has a notch formed at a corner of the distal end close to the cover crimping portion and notched over the distal end and an end close to the cover crimping portion, and
the notch satisfies 43%≤(x2/(a+c))×100≤84% and 12%≤(y/b)×100≤43% in a developed state before the conductor crimping portion is crimped to the conductor portion when a length of the barrel piece along the axial direction is a, a length along the axial direction from an end of the cover crimping portion close to the conductor crimping portion to the end of the barrel piece close to the cover crimping portion is c, a length along the axial direction from the end of the cover crimping portion close to the conductor crimping portion to an end of the notch on a side opposite to the cover crimping portion is x2, a length along an orthogonal direction from a center position of the base to the distal end of the barrel piece in the orthogonal direction orthogonal to the axial direction is b, and a length of the notch along the orthogonal direction is y.

6. A terminal before crimping comprising:
a crimp terminal that includes
a conductor crimping portion that is crimped to a conductor portion exposed from a terminal of an insulating cover portion of an electric wire of which the conductor portion having conductivity is covered with the insulating cover portion having an insulating property,
a cover crimping portion that is crimped to the insulating cover portion, and
an intermediate portion that couples the conductor crimping portion and the cover crimping portion and exposes the conductor portion, wherein
the conductor crimping portion includes a base extending along an axial direction along an axis of the conductor portion and a pair of barrel pieces respectively extending from the base on both sides of an intersection direction intersecting the axial direction, each of distal ends of the pair of barrel pieces being in contact with the conductor portion in a state where the conductor portion is wrapped and crimped by the base and the pair of barrel pieces,
the barrel piece has a notch formed at a corner of the distal end close to the cover crimping portion and notched over the distal end and an end close to the cover crimping portion, and
the notch satisfies 10%≤(x1/a)×100≤75% and 12%≤(y/b)×100≤43% in a developed state before the conductor crimping portion is crimped to the conductor portion when a length of the barrel piece along the axial direction is a, a length of the notch along the axial direction is x1, a length along an orthogonal direction from a center position of the base to the distal end of the barrel piece in the orthogonal direction orthogonal to the axial direction is b, and a length of the notch along the orthogonal direction is y.
